(19) United States
(12) Patent Application Publication
(10) Pub. No.: US 2025/0190276 A1
(43) Pub. Date: Jun. 12, 2025

(54) POLYMORPHOUS INTENT-BASED MANAGEMENT

(71) Applicant: International Business Machines Corporation, Armonk, NY (US)

(72) Inventors: Dean Har'el Lorenz, Haifa (IL); David Breitgand, Modiin (IL)

(21) Appl. No.: 18/534,814

(22) Filed: Dec. 11, 2023

(51) Int. Cl. G06F 9/50

(52) U.S. Cl. CPC G06F 9/5077; G06F 2209/5018

(57) ABSTRACT

Embodiments of the present invention provide computer-implemented methods, computer program product, and computer systems. One or more processors, in response to receiving a plurality of intents describing alternative states, calculate an optimized mixture of configurations based on the received plurality of intents. The one or more processors configure a workload partitioning mechanism to distribute a received workload between particular configurations. The one or more processors execute the workload using the configured workload partitioning mechanism that distributes load optimally across the mixture of configurations using the configured workload partitioning mechanism.

### BACKGROUND

The present invention relates generally to network services management, and more particularly to intent-based management.

Typically, a network service is an application running at the network application layer that provides data storage, manipulation, presentation, communication, or other capability which is often implemented using a client-server or peer-to-peer architecture based on application layer network protocols. Each service is usually provided by a server component running on one or more computers (often a dedicated server computer offering multiple services) and accessed via a network by client components running on other devices. However, the client and server components can both be run on the same machine.

Intent-based management of a network service refers to specifying a desired state of the service without specifying how to achieve it. This differentiates intent-based management from imperative management, in which every step of how to get to a desired state is explicitly specified. Intent-based management of a network service utilizes network administration that incorporates artificial intelligence (AI), network orchestration and/or machine learning (ML) to automate administrative tasks across a network. In general, intent-based management aims to reduce the complexity of creating, managing, and enforcing network policies and reduce the manual labor associated with traditional configuration management.

### SUMMARY

According to an aspect of the present invention, there is provided a computer-implemented method, a computer program product, and a computer system. The computer-implemented method includes, in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 is a flowchart depicting operational steps for reconciling desired states, in accordance with an embodiment of the present invention;

FIG. 3 is an example diagram of a network service, in accordance with an embodiment of the present invention; and

FIG. 4 is a block diagram of an alternate computing environment, in accordance with an embodiment of the present invention.

### DETAILED DESCRIPTION

According to an aspect of the invention, there is provided a computer implemented method. The computer-implemented method includes, in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism. In this manner, embodiments of the present invention improve network services by providing a polymorphous intent-driven management mechanism that adds flexibility allowing for better optimization in diverse domains (e.g., better optimization for application, for the platform, or both).

In embodiments, the computer-implemented that includes in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism can further include assigning incoming requests to a particular configuration of the particular configurations. Assigning incoming request to a particular configuration can automate and execute received requests which enables faster processing in multi-cloud environments.

In embodiments, the computer implemented method that includes in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism can further include adjusting alternatives to match a portion of requests. Adjusting alternatives to match a portion of the demand can dynamically adjust the implementation which enables faster processing, better reliability and performance and cost-efficiency in dynamic, multi-cloud environments.

In embodiments, the computer implemented method that includes in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism can further include continually reconciling an observed state to a more cost-efficient combination of alternative desired states. This can improve performance and ensure resources are not sitting idle. The superposition of states may represent a more cost-efficient desired states than any of the alternatives if used exclusively.

In embodiments, the computer implemented method that includes in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism can further include apportioning the received workload between one or more components of a service to be distributed between particular configurations. This can speed up processing of a received workload because resources are used efficiently and avoid bottlenecks.

In embodiments, the computer implemented method that includes in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism can further include, in response to receiving a plurality of intents, creating one or more functionally equivalent configurations that satisfies the plurality of intents. Creating one or more functionally equivalent configurations that can be apportioned allows for a superposition of alternatives functionally equivalent states that can more efficiently handle a received workload.

In embodiments, the computer implemented method that includes in response to receiving a plurality of intents describing alternative states, calculating an optimized mixture of configurations based on the received plurality of intents; configuring a workload partitioning mechanism to distribute a received workload between particular configurations; and executing the workload using the configured workload partitioning mechanism that distributes load optimally across the mixture of configurations using the configured workload partitioning mechanism can further include, in response to receiving a request for a service chain, distributing traffic between alternative equivalent paths. In this manner, embodiments of the present invention can also dynamically manage service chains.

According to an aspect of the invention, there is provided a computer program product. The computer program product includes one or more computer readable storage media and program instructions stored on the one or more computer readable storage media, the program instructions includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism. In this manner, embodiments of the present invention improve network services by providing a polymorphous intent-driven management mechanism that adds flexibility allowing for better optimization in diverse domains (e.g., better optimization for application, for the platform, or both).

In embodiments, the computer program product that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to assign incoming requests to a particular configuration of the particular configurations. Assigning incoming request to a particular configuration can automate and execute received requests which enables faster processing in multi-cloud environments.

In embodiments, the computer program product that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to adjust alternatives to match a portion of requests. Adjusting alternatives to match a portion of the demand can dynamically adjust the implementation which enables faster processing, better reliability and performance and cost-efficiency in dynamic, multi-cloud environments.

In embodiments, the computer program product that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to continually reconcile an observed state to a more cost-efficient combination of alternative desired states. This can improve performance and ensure resources are not sitting idle. The superposition of states may represent a more cost-efficient desired states than any of the alternatives if used exclusively.

In embodiments the computer program product that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to apportion the received workload between one or more components of a service to be distributed between particular configurations. This can speed up processing of a received workload because resources are used efficiently and avoid bottlenecks.

In embodiments, the computer program product that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include, program instructions to, in response to receiving a plurality of intents, create one or more functionally equivalent configurations that satisfies the plurality of intents. Creating one or more functionally equivalent configurations that can be apportioned allows for a superposition of alternatives functionally equivalent states that can more efficiently handle a received workload.

In embodiments, the computer program product that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include, program instructions to, in response to receiving a request for a service chain, distributing traffic between alternative equivalent paths. In this manner, embodiments of the present invention can also dynamically manage service chains.

According to an aspect of the invention, there is provided a computer system. The computer system comprising one or more computer processors, one or more computer readable storage media, and program instructions stored on the one or more computer readable storage media for execution by at least one of the one or more computer processors, the program instructions the program instructions including program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism. In this manner, embodiments of the present invention improve network services by providing a polymorphous intent-driven management mechanism that adds flexibility allowing for better optimization in diverse domains (e.g., better optimization for application, for the platform, or both).

In embodiments, the computer system that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to assign incoming requests to a particular configuration of the particular configurations. Assigning incoming request to a particular configuration can automate and execute received requests which enables faster processing in multi-cloud environments.

In embodiments, the computer system that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to adjust alternatives to match a portion of requests. Adjusting alternatives to match a portion of the demand can dynamically adjust the implementation which enables faster processing, better reliability and performance and cost-efficiency in dynamic, multi-cloud environments.

In embodiments, the computer system that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to continually reconcile an observed state to a more cost-efficient combination of alternative desired states. This can improve performance and ensure resources are not sitting idle. The superposition of states may represent a more cost-efficient desired states than any of the alternatives if used exclusively.

In embodiments, the computer system that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include program instructions to apportion the received workload between one or more components of a service to be distributed between particular configurations. This can speed up processing of a received workload because resources are used efficiently and avoid bottlenecks.

In embodiments, the computer system that includes program instructions to, in response to receiving a plurality of intents describing alternative states, calculate an optimized mixture of configurations based on the received plurality of intents; program instructions to configure a workload partitioning mechanism to distribute a received workload between particular configurations; and program instructions to execute the workload using the configured workload partitioning mechanism that distributes load optimally across the mixture of configurations using the configured workload partitioning mechanism can further include, program instructions to, in response to receiving a plurality of intents, create one or more functionally equivalent configurations that satisfies the plurality of intents. Creating one or more functionally equivalent configurations that can be apportioned allows for a superposition of alternatives functionally equivalent states that can more efficiently handle a received workload.

Embodiments of the present invention recognize that intent-based management of a network service are rigid. Specifically, embodiments of the present invention recognizes that current solutions for managing network services use rigid intents with a single desired state. For example, typical intent-based management specifies logical structure, behavior, and goals without identifying implementation details (e.g., an application administrator can select a concrete implementation (e.g., components, topology, etc.) to best fit a deployment environment. Other solutions such as declarative management specifies desired state rather than specific (i.e., imperative) actions. For example, a provided platform for reconciliation control loop can continuously attempt to bring the managed service to a specified, desired state (e.g., Kubernetes controllers/operations can allocate resources, setup components, handle failures, etc.).

Embodiments of the present invention further recognize certain deficiencies of current solutions. For example, embodiments of the present invention recognize that a single desired state implementation may not be the optimal or otherwise efficient option for heterogenous systems (e.g., multi-domain, multi-cloud scenarios, where each domain may have different capabilities and costs associated with them). In other words, a single desired state might not always be the most cost-efficient or have the most optimal performance in dynamic conditions (e.g., changes in demand, communication bottlenecks, resource availability, etc.).

Current solutions involving vertical and horizontal auto-scaling provide solutions for the platform adjusting the size of the topology to match load. Application deployment specifies auto-scalable components, min/max sizes, and performance metrics, wherein the platform handles routing (i.e., load balancing). Embodiments of the present invention recognize that these solutions can be limited in that only scaling actions are allowed. In other words, these solutions fail to provide features that allow for adding, removing, and/or modifying any components. These solutions also cannot change the order of execution.

Embodiments of the present invention recognize that serverless solutions can allow the platform to scale service to zero in absence of a load. These solutions include limitations similar to auto-scaling. Further, under sustained load, serverless components are always running and are not different from any other application component.

In instances where solutions provide dynamic selection of Application Programming Interface (API) implementation, the implementation can be chosen dynamically for a specific service or API and is common in software engineering. However, embodiments of the present invention recognize certain limitations with this approach. For example, embodiments of the present invention recognize that these solutions are typically only dynamic at initializations based on the run-time platform being used. This solution cannot mix different implementation alternatives in the same solution (e.g., be integrated with different components and/or topologies).

Embodiments of the present invention thus recognize that current declarative management and intent-driven management systems are supplied with a single desired state and continuously reconciling the observed state to the single desired state is suboptimal. Recognizing these deficiencies, embodiments of the present invention provide solutions for a polymorphous desired state, polymorphous intent, and polymorphous reconciliation. For example, an application manager can specify a plurality of alternative desired states and allow superposition of possible desired states. These alternative desired states can be functionally equivalent but may differ in certain efficiencies (e.g., cost, resources, etc.). More specifically, particular configurations corresponding to differently implemented, but functionally equivalent desired states, differ in terms of cost-efficiency under different deployment circumstances. For example, if compute is less expensive than communication when serving certain customers, a desired state implementation alternative can be used that includes data compression component that compresses network traffic, thus reducing the network cost while paying more for hosting the additional compressor component, as long as the overall cost is lower than without using compression. However, for another subset of users it might so happen that the cost of communicating is cheap while the cost of hosting compute components is more expensive. In this scenario, embodiments of the present invention can implement the communication link will without compression. This results in a mixture of desired state implementations, i.e., it is a polymorphous state. In some cases, a specific alternative may have internal alternatives for its sub-components. Thus, embodiments of the present invention provide mechanisms for a plurality of desired states' declaration to be used that continuously reconciles an observed state to a combination of the desired states, where the combination results in the most cost-efficient overall state of the managed system, as discussed in greater detail later in this Specification.

In this manner, embodiments of the present invention improve network services by providing a polymorphous intent-driven management mechanism that adds flexibility allowing for better optimization in diverse domains (e.g., better optimization for application, for the platform, or both). Embodiments of the present invention also allow platforms to manage the superposition, relieving the application developer and/or manager from having to dynamically adjust the implementation which enables faster processing, better reliability, and performance in dynamic, multi-cloud environments.

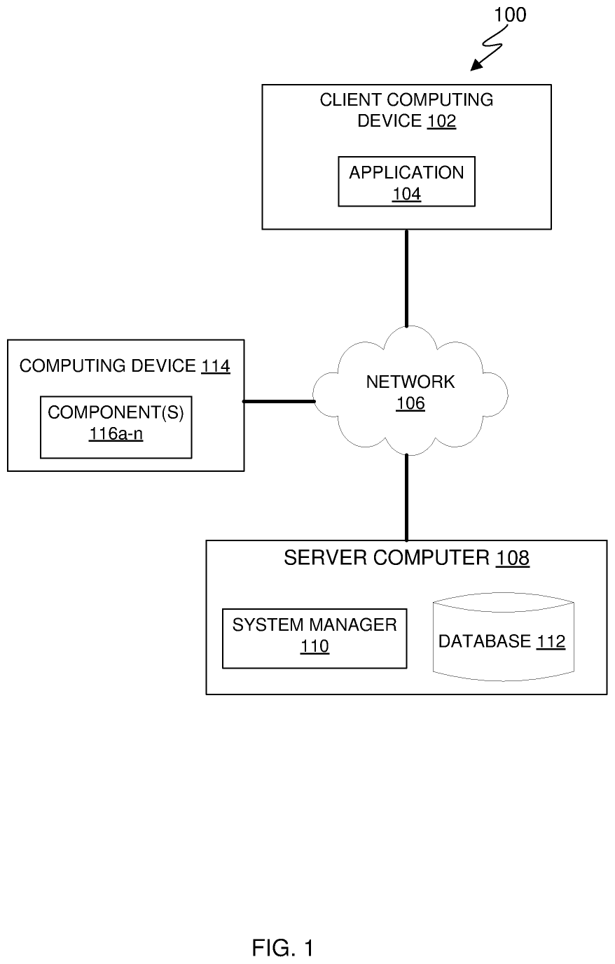

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

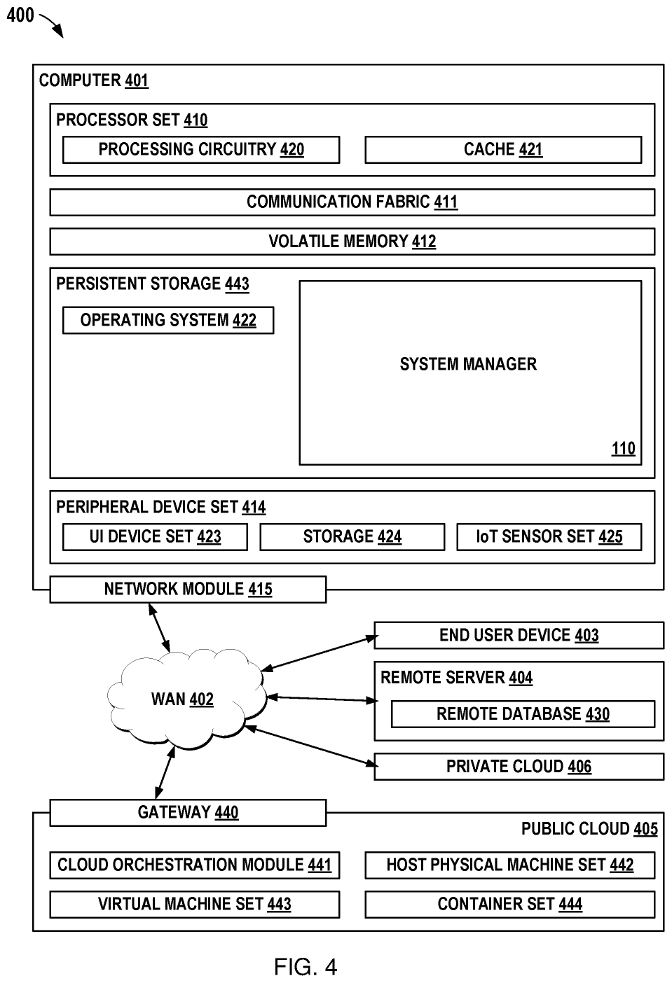

Computing environment 100 includes client computing device 102, server computer 108, and computing device 114 all interconnected over network 106. Client computing device 102, server computer 108, and computing device 114 can be a standalone computer device, a management server, a webserver, a mobile computing device, or any other electronic device or computing system capable of receiving, sending, and processing data. In other embodiments, client computing device 102, server computer 108, and computing device 114 can represent a server computing system utilizing multiple computers as a server system, such as in a cloud computing environment. In another embodiment, client computing device 102, server computer 108, and computing device 114 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102, server computer 108, and computing device 114 each represent a computing system utilizing clustered computers and components (e.g., database server computers, application server computers, etc.) that act as a single pool of seamless resources when accessed within computing environment 100. In some embodiments, client computing device 102, server computer 108, and computing device 114 are a single device. Client computing device 102, server computer 108, and computing device 114 may include internal and external hardware components capable of executing machine-readable program instructions, as depicted and described in further detail with respect to FIG. 4.

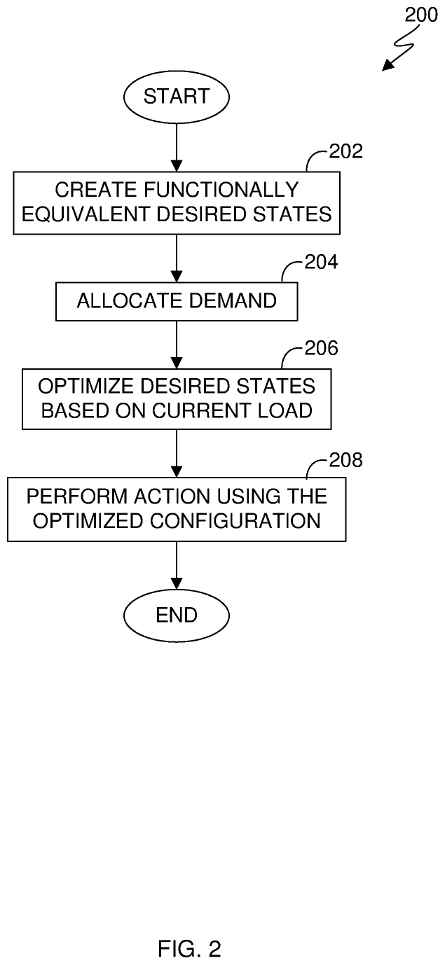

In this embodiment, client computing device 102 is a user device associated with a user and includes application 104. Application 104 communicates with server computer 108 to access system manager 110 (e.g., using TCP/IP) to access user information and database information. Application 104 can further communicate with system manager 110 to continuously reconcile an observed state to a combination of desired states, as discussed in greater detail in FIGS. 2-4. In this embodiment, client computing device 102 can be used to transmit information to manage another system. For example, client computing device 102 can transmit information to manage computing device 114 having one or more components, e.g., components 116a-n, performing a service. In some embodiments, each component of components 116a-n may be alternative instances performing the same function. In other embodiments, components 116a-n may perform different functions. For example, a configuration (i.e., a unique combination of one or more components, also referred to as a “state”) can include a combination of one or more components to perform a particular service. In this embodiment, an alternative configuration may include a different combination of the one or more components to perform the same service but with different cost efficiencies. In yet other embodiments, components 116a-n may include components that perform the same function and include other components that perform different functions of a service.

In some embodiments, client computing device 102 can be the managed system transmitting information including a plurality of intents and at least one policy per received intent. Information can also include cost/performance tradeoffs for different alternatives (i.e., configuration of components) and optimization goals. Further, in some instances, information can also describe service topologies.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts system manager 110 and database 112. In this embodiment, system manager 110 resides on server computer 108. In other embodiments, system manager 110 can have an instance of the program (not shown) stored locally on client computing device 102. In other embodiments, system manager 110 can be a standalone program or system that can be integrated in one or more computing devices having a display screen.

System manager 110 continuously reconciles an observed state to a combination of desired states that results in an optimal performance environment. For example, system manager 110 can calculate and configure steps for fulfilling intents and combinations thereof. Once a combination of desired state is created, system manager 110 configures a workload partitioning component that partitions load among the configurations in the combination of configurations. In other words, system manager 110 provides a mechanism for to generalize intent-driven management from one desired state to a combination thereof, because such a combination allows to dynamically react on the load conditions in the managed system and arrives at more cost-efficient managed system. In this manner, system manager 110 can specify the desired state as a polymorphous superposition of alternative functionally equivalent states rather than choosing a singular possible implementation. System manager 110 can dynamically update the polymorphous desired state according to the polymorphous intent and system state. In some instances, system manager 110 can include a load balancer (not shown) that controls the superposition of states (e.g., the reconciliation loop) and each individual alternative state. In response to any change to the superposition of alternative states, system manager 110 triggers this reconciliation of each affected alternative.

As used herein, an observed state refers to current processing conditions of a received request that can include one or more configurations of components performing a service, and other relevant system information (e.g., power consumption, bandwidth, network connectivity, etc.). Each configuration can include one or more components that, when executed perform a service. Each configuration can be functionally equivalent (i.e., perform the same service) but may include different components having different cost efficiencies. For example, if compute is less expensive than communication when serving certain customers, a desired state implementation alternative (i.e., a desired configuration) can include data compression component that compresses network traffic, thus reducing the network cost while paying more for hosting the additional compressor component, if the overall cost is lower than without using compression. However, for another subset of users it might so happen that the cost of communicating is cheap while the cost of hosting compute components is more expensive. In this scenario, a desired state implementation alternative can implement the communication link without compression.

The superposition of desired alternative configurations or superposition of desired alternative states fulfills a received intent and refers to one or more configuration of components that are functionally equivalent but may represent a more cost-efficient desired state than any of the alternative configuration of components is used exclusively. In other words, each configuration may be an alternative configuration (i.e., an alternative desired state), each able to fulfill the expected behavior required by the received intent, regardless of whether their functionality is the same. Put another way, any of the alternative configurations or combination of alternative states is considered a viable implementation of the intent. An “intent” refers to one or more statements of the desired characteristics, behavior, or outcomes from a system (e.g., an operator's expectations from the managed networked service). For example, an intent may be stated as a utility level goal that describes the properties of a satisfactory outcome rather than prescribing specific ways to achieve that goal.

Continuing the example above, the superposition of desired alternative states can refer to the desired configuration that includes a data compression component when compute processing is less expensive than communication and a communication link without compression. This results in a mixture of desired state implementations, i.e., it is a polymorphous state that is an optimal performance environment that is a balance of performance and cost metrics for a given set of conditions and constraints. In this embodiment, system manager 110 can specify cost and performance tradeoffs to govern superposition of multiple states.

System manager 110 can also specify boundaries, tolerances, and performance metrics. In this manner, system manager 110 can mix desired states to attain improved cost and performance tradeoff optimization. For example, using a reconciliation loop, system manager 110 can dynamically change the superposition of possible desired states.

The solutions provided herein can allow the platform being managed to route each request to use one desired state alternative. In this manner, every received request can be routed to a unique path in a superposition and demand is split according to the desired superposition. The platform provided by embodiments of the present invention can recursively/hierarchically reconcile each of the desired state alternatives. In other words, the desired state of each alternative can be dynamically updated to match the reconciled superposition. Embodiments of the present invention provide a per-alternative reconciliation process attempts to bring the relevant portion of the managed service to its updated desired state as discussed in greater detail, later in this Specification.

Database 112 stores received information and can be representative of one or more databases that give permissioned access to system manager 110 or publicly available databases. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 is a flowchart 200 depicting operational steps for reconciling desired states, in accordance with an embodiment of the present invention.

In step 202, system manager 110 creates functionally equivalent desired states. In this embodiment, system manager 110 creates functionally equivalent desired states in response to receiving information from one or more components of computing environment 100 (e.g., database 112) by creating components (and through configuration) towards functionally equivalent desired states. Unlike existing management systems that corrects the system until it reaches a single desired state, embodiments of the present invention allow for convergence to multiple states simultaneously. For example, one embodiment may include a combination of systems, each having a single (different) desired state and each handling some fraction of the demand as allocated in step 204. In this embodiment, information received can include a plurality of intents and at least one policy per received intent. Received information can also include cost/performance tradeoffs for different alternatives and optimization goals. Further, in some instances, received information can also describe service topologies.

As mentioned above, “intent”, refers to one or more statements of the desired characteristics, behavior, or outcomes from a system. From the human operator's perspective, intents express the operator's expectations from the managed networked service. Ideally, to decouple an intent from its implementation steps, intents are preferably expressed declaratively, that is, highlighting what shall be achieved and not how to achieve the outcome. For example, an intent may be stated as a utility level goal that describes the properties of a satisfactory outcome rather than prescribing specific ways to achieve that goal.

Thus, where “intent” is defined as the desired state of the system, the desired state of the system references a combination of components from the state space of configurations and components. In this embodiment, system manager 110 can create functionally equivalent desired states from the received intent which could represent a plurality of cost and performance tradeoffs. For application deployment, these desired states may represent multiple alternative topologies, all of which are functionally equivalent (i.e., deploying any of them would meet the desired state). In the specific case of application services that are defined through function chain topologies, system manager 110 (e.g., via an application developer) provides “choice” points, where the topology can be fulfilled with any one of multiple chain continuations. A “state” as used herein, refers to a static moment in time and respective system configurations and components at that specific moment in time.

In some embodiments, system manager 110 maps the received intent to available strategies for describing and controlling the system while accounting for the system's observable measurable properties. For example, where the system being managed and optimized by system manager 110 is a mobile network, the system's measurable properties may include the number and location of network elements, the values of its respective configuration parameters and context (e.g., network elements such as mountains, buildings, ongoing traffic, etc.). In a mobile network, these observable properties may include signal strength, throughput, or latency measured by end user devices, performance management data like counters on network events, and all traces of the signaling interfaces.

In step 204, system manager 110 allocates demand. In this embodiment, system manager 110 allocates demand in response to receiving a user request. In this embodiment, system manager 110 utilizes a load balancer to allocate demand. In other embodiments, system manager 110 can allocate demand according to user specified instructions. In certain embodiments, system manager 110 can allocate demand by configuring a workload partitioning mechanism (a separate component) to distribute received workload between particular configurations. In this embodiment, the workload partitioning mechanism can partition loads based on the characteristics of the incoming requests, e.g., where do they originate from. Load balancing may also depend on the load in the system and resource utilization inside the managed application. The workload partitioner (i.e., the workload partitioning mechanism) groups requests to be allocated for processing by a specific configuration. Each specific configuration is horizontally elastic and has its own load balancer independent of the workload partitioner. In some embodiments, system manager 110 can adjust each of the alternatives to match the portion of the demand the received request would be assigned to.

In step 206, system manager 110 optimizes desired states based on current load. In this embodiment, system manager 110 optimizes desired states based on current load, reconciling desired states against received intents and associated policies against the service topology. In one embodiment, system manager 110 uses Mixed Integer and Linear Programming (MILP) with relaxation to Linear Program (LP). In other words, system manager 110 optimizes desired states by calculating an optimal polymorphous state based, at least in part, on received intents each intent describing a possible desired state, current load, and network topology. For example, in instances where there includes three components for a service in a system, each component used to some degree to complete a received task, system manager 110 can calculate an optimal polymorphous desired state that utilizes varying portions (e.g., 75% of component one, 20% of component two, and 5% of component three) of each of the three components (as opposed to utilizing just one component to fulfill the request) so that each of the three components can work harmoniously (e.g., polymorphous superposition). In this manner, while there are three possible configurations, each configuration is functionally equivalent but have different cost-efficiencies because they include different components. In other words, system manager 110 can apportion a received task (i.e., workload) to be performed by one or more alternatives (e.g., configurations of one or more components) within the network based on the current load according to particular configurations that satisfy the received intents.

In this way, system manager 110 can provide a solution that achieves a mix of the desired states and can configure the system to allocate demand accordingly. For example, system manager 110 may use a solver that optimizes for allocation of the different alternatives (i.e., the functionally equivalent desired states) using a fixed proportion, while simultaneously finding the optimal portion. In instances where system manager 110 receives a request to optimize a service/function chain, system manager 110 can configure a load balancer at each “choice” point to forward the traffic based on the optimal portion for that point. In this instance, an alternative component may perform the same function as the component it replaces.

In step 208, system manager 110 performs an action using the optimized configuration. In this embodiment, application manager performs an action by executing the workload according to the optimization. For example, system manager 110 distributes load among the states according to the calculated optimal desired states to reconcile the observed state to the optimal combination of desired states.

In instances where system manager 110 has already calculated an optimized configuration, system manager 110 can assigning future incoming requests to a particular configuration. System manager 110 can then execute the incoming requests according to the particular configuration. In instances where system manager 110 manages a service chain, system manager 110 can assign the received request to a particular node of the service chain or alternative instance in the service chain. In some instances, based on the optimized configuration, system manager 110 can partition or otherwise split the workload associated with received request to be fulfilled by multiple other instances in of a service in the service chain.

In some instances, system manager 110 can begin execution according to the optimized configuration and, in response to receiving an update (e.g., a change to the superposition of alternative states), dynamically recalculate the optimal configuration for each affected alternative. In this embodiment, an update may be any change to system. For example, system manager 110 can dynamically recalculate the optimal configuration based on receiving changes to the topology of the system, a change in performance metrics, or a change in any other observable properties.

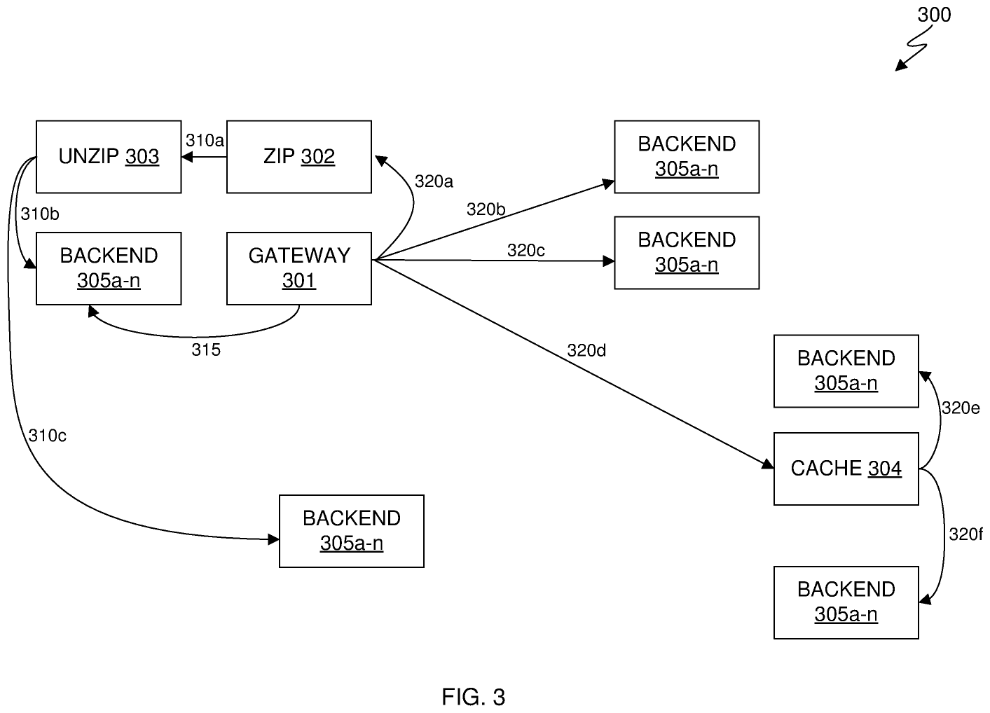

FIG. 3 is an example diagram 300 of a network service, in accordance with an embodiment of the present invention.

In this example, in response to receiving intents that define desired tradeoffs (e.g., minimize cost while meeting minimal service level objectives), system manager 110 has created three functionally equivalent desired states representing a service topology (i.e., a collection of network functions). The three gateway access points (e.g., GW access) connected to a backend server for remote processing distributed at separate physical regions. In one example, a GW access is connected directly to a backend server, while another GW access includes compression and decompression components (e.g., zips and unzips) data before reaching the backend server. A third GW access includes a cache to improve performance over slow connections to the backend server.

More specifically, example diagram 300 shows an example network service that utilizes polymorphous desired state, polymorphous intent, and polymorphous reconciliation-based management across the three functionally equivalent desired states. A single gateway access point is shown (e.g., gateway 301) with optional components are shown such as compression and decompression components (e.g., zip 302 and unzip 303 for low bandwidth or otherwise expensive links shown as the longer connection lines connected to multiple backend servers (e.g., backend 305a-n) distributed over separated physical regions. Example 300 also shows cache 304 (or other accelerator) for better performance over slow connections. These optional components offer a tradeoff between compute resources when functions are deployed, network resources when they are not deployed, and performance. In this example, system manager 110 can determine whether to use these functions depending on availability of resources and dynamic network conditions. System manager 110 can manage incoming requests received for gateway 301 and any of its connections (e.g., expensive inter-cloud link, cheap fast, intra-cloud link, capacitated, pre-paid links, and slow, long-haul links) to any of its components (e.g., zip 302, unzip 303, and backend 305-a-n).

System manager 110 then chooses which network functions to deploy to fulfill the received intents (e.g., use any combination of these optimal components such as deploy cache only on some regions, deploy compression only on specific links, etc.). For example, system manager 110 can, utilizing a load balancer, receive an incoming request, assign the workload associated with the request to use one or more components (e.g., zip 302 and unzip 303) using a combination of a cheap, fast intra-cloud link (e.g., 320a) and expensive inter-cloud links (e.g., links 310a, 310b) within the same region to a backend server or to use a cheap, fast intra-cloud link (e.g., 310c) before reaching a different backend server across a different region. In response to receiving another incoming request to access gateway 301, system manager 110 can configure the workload partitioning mechanism to distribute a first portion of the workload from gateway 301 to use cheap, fast intracloud links (e.g., links 320b and 320c) to backend 305a-n while distributing a second portion to use a slow, long-haul link (e.g., link 320d) using cache 304 (or other accelerator) for better performance over the slow-long haul link across a different region before reaching backend 305a-n using either link 320e and link 320f. In response to receiving another request, system manager 110 can apportion a work to either use a capacitated, pre-paid link (e.g., link 315) to a backend server.

System manager 110 can manage the functions of the network service (e.g., each network function may auto-scale according to load, restart failed network functions, etc.). System manager 110 can distribute traffic between alternative equivalent paths as it receives incoming requests. System manager 110 can then update the topology and dynamically choose which network functions to deploy (e.g., shut down compress/decompression functions if demand decreases over a specific logical link).

FIG. 4 depicts an alternate block diagram of components of computing systems within computing environment 100 of FIG. 1, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as system manager 110 (also referred to as block 110) which continuously reconciles desired states and provides polymorphous intent-based management as discussed previously with respect to FIGS. 2-3.

In addition to block 110, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 110, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 110 in persistent storage 413.

COMMUNICATION FABRIC 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface type operating systems that employ a kernel. The code included in block 110 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

What is claimed is:

1. A computer-implemented method comprising:
in response to receiving a plurality of intents describing alternative states, calculating an optimized mixture of configurations based on the received plurality of intents;
configuring a workload partitioning mechanism to distribute a received workload between particular configurations; and
executing the workload using the configured workload partitioning mechanism that distributes load optimally across the mixture of configurations using the configured workload partitioning mechanism.

2. The computer-implemented method of claim 1, further comprising:
assigning incoming requests to a particular configuration of the particular configurations.

3. The computer-implemented method of claim 1, further comprising:
adjusting alternative components to match a portion of requests.

4. The computer-implemented method of claim 1, further comprising:
continually reconciling an observed state to a more cost-efficient combination of desired alternative states.

5. The computer-implemented method of claim 1, wherein configuring a workload partitioning mechanism to distribute received workload between particular configurations comprises:
apportioning the received workload between one or more components of a service to be distributed between particular configurations.

6. The computer-implemented method of claim 1, further comprising:
in response to receiving a plurality of intents, creating one or more functionally equivalent configurations that satisfies the plurality of intents.

7. The computer-implemented method of claim 1, further comprising:
in response to receiving a request for a service chain, distributing traffic between alternative equivalent paths.

8. A computer program product comprising:
one or more computer readable storage media and program instructions stored on the one or more computer readable storage media, the program instructions comprising:
program instructions to, in response to receiving a plurality of intents describing alternative states, calculating an optimized mixture of configurations based on the received plurality of intents;
program instructions to configure a workload partitioning mechanism to distribute a received workload between particular configurations; and
program instructions to execute the workload using the configured workload partitioning mechanism that distributes load optimally across the mixture of configurations using the configured workload partitioning mechanism.

9. The computer program product of claim 8, wherein the program instructions stored on the one or more computer readable storage media further comprise:
program instructions to assign incoming requests to a particular configuration of the particular configurations.

10. The computer program product of claim 8, wherein the program instructions stored on the one or more computer readable storage media further comprise:
program instructions to adjust alternative components to match a portion of requests.

11. The computer program product of claim 8, wherein the program instructions stored on the one or more computer readable storage media further comprise:
program instructions to continually reconcile an observed state to a more cost-efficient combination of desired alternative states.

12. The computer program product of claim 8, wherein the program instructions to configure a workload partitioning mechanism to distribute received workload between particular configurations comprise:
program instructions to apportion the received workload between one or more components of a service to be distributed between particular configurations.

13. The computer program product of claim 8, wherein the program instructions stored on the one or more computer readable storage media further comprise:
program instructions to, in response to receiving a plurality of intents, create one or more functionally equivalent configurations that satisfies the plurality of intents.

14. The computer program product of claim 8, wherein the program instructions stored on the one or more computer readable storage media further comprise:
program instructions to, in response to receiving a request for a service chain, distribute traffic between alternative equivalent paths.

15. A computer system comprising:
one or more computer processors;
one or more computer readable storage media; and
program instructions stored on the one or more computer readable storage media for execution by at least one of the one or more computer processors, the program instructions comprising:
program instructions to, in response to receiving a plurality of intents describing alternative states, calculating an optimized mixture of configurations based on the received plurality of intents;
program instructions to configure a workload partitioning mechanism to distribute a received workload between particular configurations; and
program instructions to execute the workload using the configured workload partitioning mechanism that distributes load optimally across the mixture of configurations using the configured workload partitioning mechanism.

16. The computer system of claim 15, wherein the program instructions stored on the one or more computer readable storage media further comprise:
program instructions to assign incoming requests to a particular configuration of the particular configurations.

17. The computer system of claim 15, wherein the program instructions stored on the one or more computer readable storage media further comprise:
program instructions to adjust alternative components to match a portion of requests.

18. The computer system of claim 15, wherein the program instructions stored on the one or more computer readable storage media further comprise:
program instructions to continually reconcile an observed state to a more cost-efficient combination of desired alternative states.

19. The computer system of claim 15, wherein the program instructions to configure a workload partitioning mechanism to distribute received workload between particular configurations comprise:
program instructions to apportion the received workload between one or more components of a service to be distributed between particular configurations.

20. The computer system of claim 15, wherein the program instructions stored on the one or more computer readable storage media further comprise:
program instructions to, in response to receiving a plurality of intents, create one or more functionally equivalent configurations that satisfies the plurality of intents.
